(19) United States
(12) Patent Application Publication
(10) Pub. No.: US 2004/0225803 A1
(43) Pub. Date: Nov. 11, 2004

(54) Computer system with hot swap function

(76) Inventor: Kao Yi Sheng, Shijr City (TW)

Correspondence Address: SHAW PITTMAN, IP GROUP, 1650 TYSONS BOULEVARD, SUITE 1300, MCLEAN, VA, 22102, US

(21) Appl. No.: 09/833,571

(22) Filed: Apr. 13, 2001

(30) Foreign Application Priority Data
Sep. 14, 2000 (CN) 089119023

(51) Int. Cl. G06F 13/00

(52) U.S. Cl. 710/303

(57) ABSTRACT

This invention relates to a computer system with hot swap function, the computer system comprises a computer peripheral device having a signal connector in a predetermined position, a mother board having a Basic Input Output System (BIOS), a software controller for controlling the signal communication of the computer system and the power of the computer peripheral device, and a circuit board forming on one slot which is used for accommodating the computer peripheral device. The circuit board comprises a first connector and a second connector for connecting with the computer peripheral device, and a signal connection device for connecting with the motherboard and the software controller. The first connector and the second connector connect with the signal connection device through the circuitry of the circuit board. The computer peripheral device connects with one of the first connector and the second connector selectively by means of the predetermined position of the signal connector, the signal connection device judges the type of the computer peripheral device from the connection signal and transmits the result of the judgment to the mother board, and then the software controller starts the computer peripheral device according to the result of the judgment.

### REFERENCE TO RELATED APPLICATION

The present application claims priority to Taiwan application No.089119023, entitled “Computer system with hot swap function,” filed on Sep. 14, 2000.

### BACKGROUND OF THE INVENTION

1. Field of the Invention

This invention relates to a computer system with hot swap function, and more particularly to a computer system capable of judging the position and the type of a computer peripheral device automatically, so that users can either insert or swap the computer peripheral device to meet their requirements.

2. Description of the Related Art

The new generation of information products emphasizes on cobwebby, small, having the ability of upgrade and swap. Thus, users can change the computer peripheral device from the host to meet their requirements. During the moment of inserting and swapping the computer peripheral device the change of current may influence and even damage the normal operation of the computer, so the conventional operation of inserting and swapping must be done when the computer is shut off. However, when users need to change several computer peripheral devices or when the platform is a server, shutting off the computer is not practical for users. Therefore, the computer system capable of inserting and swapping the computer peripheral device when the computer is in a running state, so called hot swap operation, is created.

Up to the present most computer systems with hot swap function utilize SCSI (Small Computer System Interface) and the host only provides one single slot for one computer peripheral device. Accordingly, it is inflexible to change the computer peripheral device, and it takes more room for the slot as the number of the computer peripheral device increases.

### SUMMARY OF THE INVENTION

The primary purpose of this invention is to provide a computer system capable of judging the position and the type of a computer peripheral device automatically, so that users can hot swap the computer peripheral device and the operation will not take the resources of the CPU (Central Processing Unit), and not influence or damage the normal operation of the computer.

Besides, the present invention provides a computer system with hot swap function, the host does not need a complicated software or hardware scheme, users can change the position of the computer peripheral device flexibly and do the hot swap operation.

The above is a brief description of some deficiencies in the prior art and advantages of this invention. Other features, advantages and embodiments of the invention will be apparent to those skilled in the art from the following description, accompanying drawings and appended claims.

### BRIEF DESCRIPTION OF DRAWINGS

The following detailed description, given by way of examples and not intended to limit the invention to the embodiments described herein, will be best understood in conjunction with the accompanying drawings, in which:

FIG. 1 is a schematic diagram of the computer system with hot swap function of the present invention.

FIG. 2 is a block diagram of the computer system with hot swap function of the present invention.

FIG. 3A is a pin diagram of the signal connection device of the computer system of the present invention.

FIG. 3B is a truth table of the signal connection device of the computer system of the present invention.

FIG. 4A is a flow chart that the computer peripheral device inserts into the host when the computer is in a running state.

FIG. 4B is a flow chart that the computer peripheral device swaps from the host when the computer is in a running state.

### DETAILED DESCRIPTION OF THE INVENTION

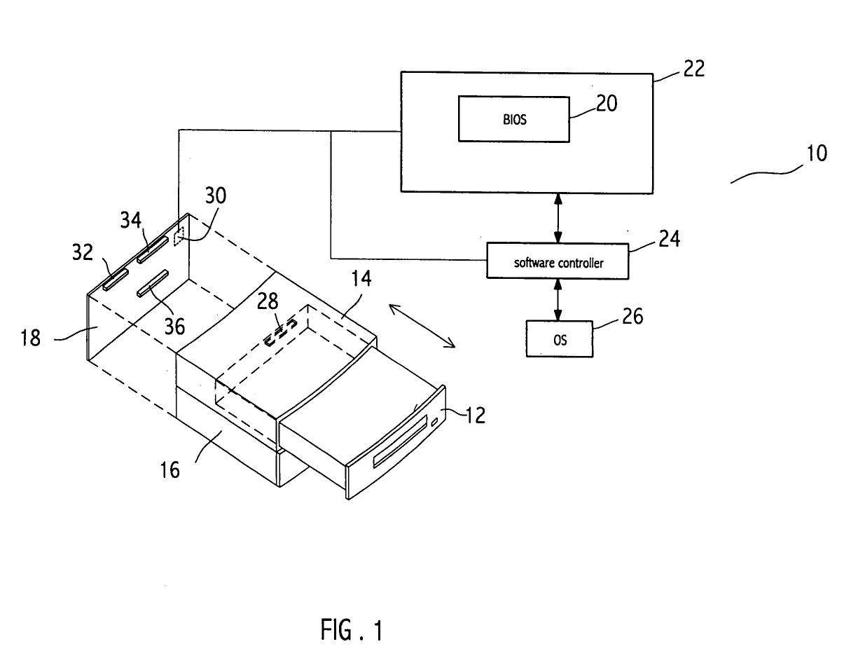

Please refer to FIG. 1. FIG. 1 is a schematic diagram of the computer system with hot swap function of the present invention. According to FIG. 1, the computer system 10 comprises a computer peripheral device 12, a first slot 14, a second slot 16, a circuit board 18, a mother board 22 having a basic input output system (BIOS) 20, a software controller 24 for controlling the signal communication of the computer system 10 and the power of the computer peripheral device 12, and an operation system 26 providing hot swap operation with safe function. Wherein the computer peripheral device 12 has a signal connector 28 with FDD interface or a signal connector 29 with IDE2 interface for connecting with the circuit board 18. The first slot 14 and the second slot 16 are collocated vertically, and are used for accommodating the computer peripheral device 12. Since the specification of the connection of a floppy disk drive is the FDD interface, and IDE interface can supply two computer peripheral devices connecting with the host, the computer peripheral device 12 can be one of the floppy disk drive, hard disk drive, CD-ROM, CD-R/W, DVD and those data storage devices. The position of the circuit board 18 is opposite to that of the first slot 14 and the second slot 16, the circuit board 18 comprises the circuitry (not shown), a signal connection device 30 for connecting with the mother board 22 and the software controller 24, a FDD connector 32 connecting with the signal connector 28, an IDE2 master connector 34 and an IDE2 slave connector 36 connecting with the signal connector 29. Consequently, computer peripheral device 12 connects with one of the FDD connector 32, IDE2 master connector 34 and an IDE2 slave connector 36 selectively by means of the predetermined position of the signal connector 28 and the signal connector 29.

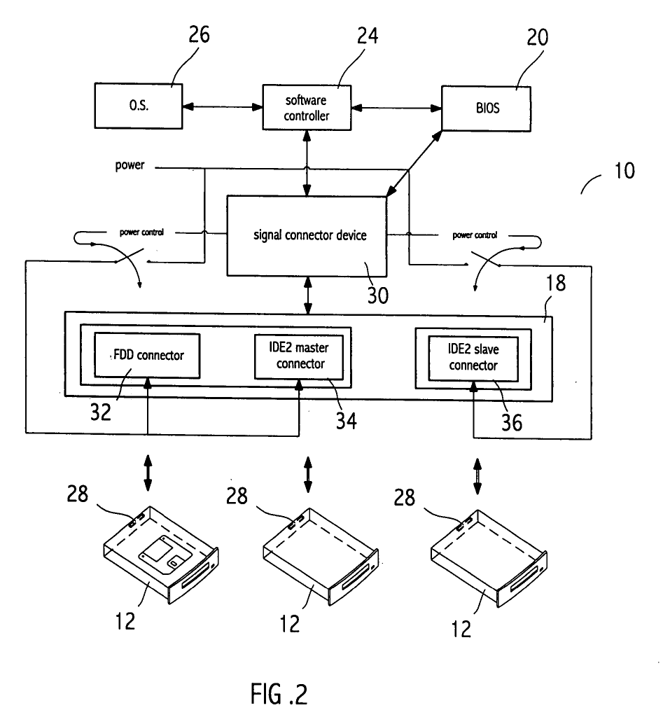

Please refer to FIG. 2. FIG. 2 is a block diagram of the computer system with hot swap function of the present invention. As shown in FIG. 2, when the computer peripheral device 12 is to be inserted into the first slot 14 or the second slot 16 in the condition of not shutting off the computer, the computer system 10 of the present invention will execute the following steps: Firstly, if the computer peripheral device 12 is with the FDD interface, then the signal connector 28 connects with the FDD connector 32 of the circuit board 18. If the computer peripheral device 12 is with the IDE interface, then the signal connector 28 connects with one of the IDE2 master connector 34 and the IDE2 slave connector 36 of the circuit board 18. Secondly, the circuitry (not shown) of the circuit board 18 transmits the connection signal to the signal connection device 30, and the signal connection device 30 will detect the type of the computer peripheral device 12 automatically. Then, the BIOS 20 gets the detection result from the signal connection device 30, and the software controller 24 will call the BIOS 20 and get the detection result. Finally, the software controller 24 provides the computer peripheral device 12 with power and then starts it. Similarly, when the computer peripheral device 12 is to be swapped from the first slot 14 or the second slot 16 in the condition of not shutting off the computer, the computer system 10 of the present invention will execute the following steps: Firstly, the software controller 24 gets the information of the position of the computer peripheral device 12. Then, the software controller 24 shuts off the computer peripheral device 12 and disconnects it. Finally, the signal connector 28 releases from the circuit board 18. Besides, the OS 26 of the computer system 10 can also check users' competence through the software controller 24 to decide whether starting or shutting off the computer peripheral device 12.

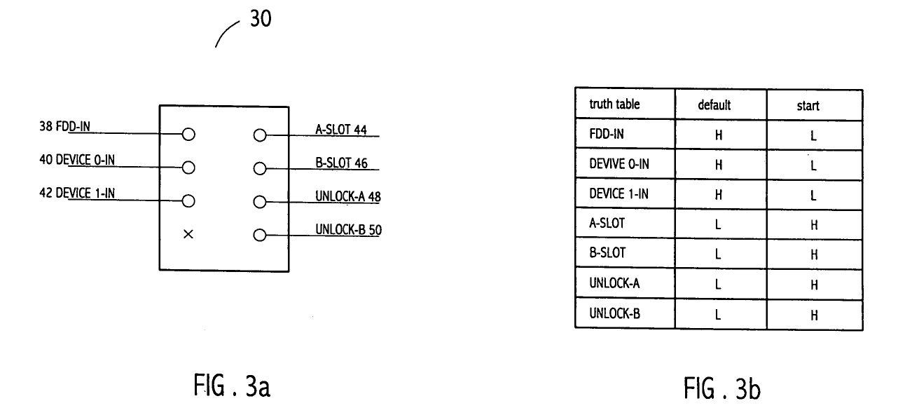

Please refer to FIG. 3A, It is a pin diagram of the signal connection device of the computer system of the present invention. FIG. 3B is a truth table of the signal connection device of the computer system of the present invention. As shown in FIG. 3A, the signal connection device 30 has seven pins with the functions as follows: When the signal connector 28 of the floppy disk drive connects with the FDD connector 32 of the circuit board 18, the circuitry of the circuit board 18 will transmit the connection signal to the FDD_IN pin 38. Similarly, when the signal connector 29 of the IDE device connects with one of the IDE2 master connector 34 and the IDE2 slave connector 36 of the circuit board 18, the circuitry of the circuit board 18 will transmit the connection signal to one of the DEVICE0_IN pin 40 and the DEVICE1_IN pin 42. According to FIG. 3B, all of the default voltage of the preceding FDD_IN pin 38, DEVICE0_IN pin 40 and the DEVICE1_IN pin 42 are high and will switch to low once being triggered. Thus, by detecting the change of the voltage of these pins the signal connection device 30 can judge the position and the type of the computer peripheral device 12 connecting with the circuit board 18. Moreover, the result of the judgment will transmit to the BIOS 20 and the software controller 24 of the computer system 10, and through one of the A_SLOT pin 44 and the B_SLOT pin 46 the software controller 24 will provide the computer peripheral device 12 with power and start it. Furthermore, the UNLOCK_A pin 48 and the UNLOCK_B pin 50 will transmit the command from OS 26 to the first slot 14 and the second slot 16 which is for accommodating the computer peripheral device 12, and decide whether to unhook the electrical lock (not shown) of the first slot 14 and the second slot 16.

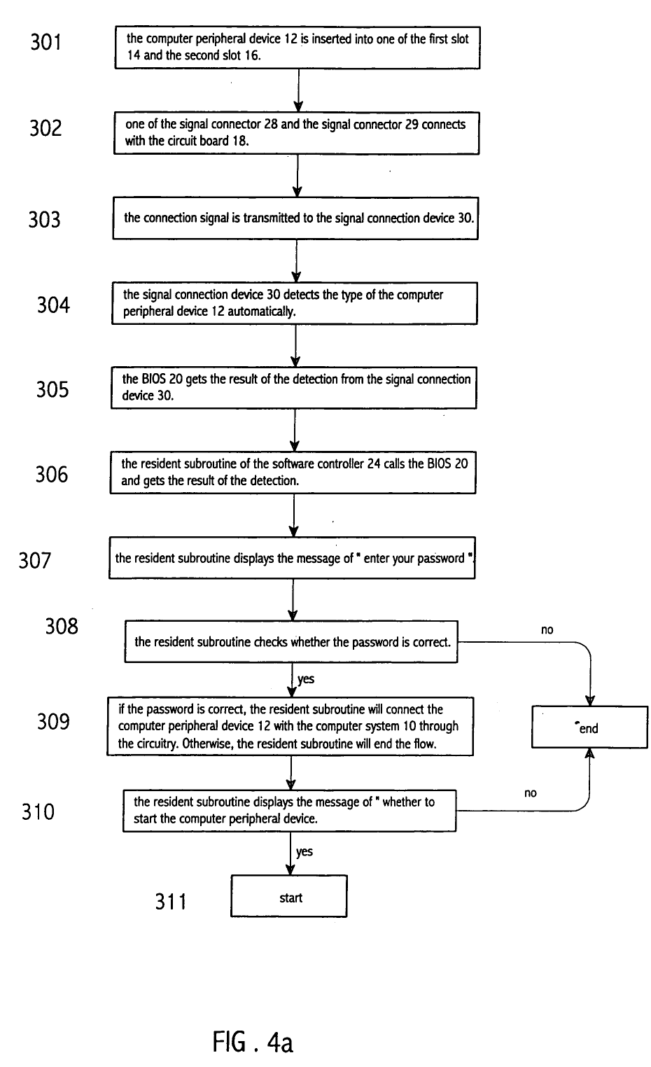

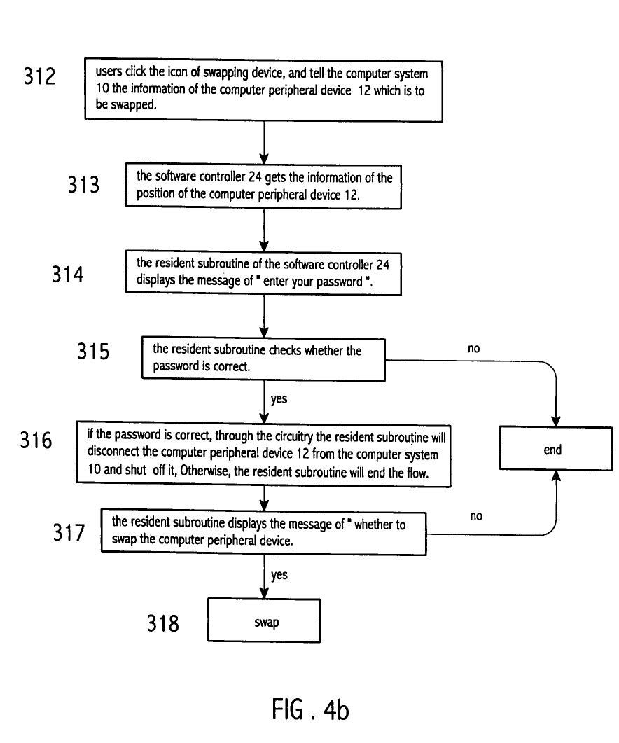

Please refer to FIG. 4A, it is a flow chart that the computer peripheral device inserts into the host when the computer is in a running state. Wherein the computer system 10 provides a simple resident subroutine, and the resident subroutine is needed only when the hot swap function is being executed. Therefore, the resident subroutine does not take the resources of the CPU. The flow comprises the following steps: Firstly, in step 301, the computer peripheral device 12 is inserted into one of the first slot 14 and the second slot 16. Secondly, in step 302, one of the signal connector 28 and the signal connector 29 connects with the circuit board 18. Then, in step 303, the connection signal is transmitted to the signal connection device 30. And then, in the step 304, the signal connection device 30 detects the type of the computer peripheral device 12 automatically. Next, in the step 305, the BIOS 20 gets the result of the detection from the signal connection device 30. Following the step 305, in the step 306, the resident subroutine of the software controller 24 calls the BIOS 20 and gets the result of the detection. And in step 307, the resident subroutine displays the message of “enter your password”. Farther, in step 308, the resident subroutine checks whether the password is correct. According to step 308, in step 309, if the password is correct, the resident subroutine will connect the computer peripheral device 12 with the computer system 10 through the circuitry. Otherwise, the resident subroutine will end the flow. Further, in step 310, the resident subroutine displays the message of “whether to start the computer peripheral device”. Furthermore, in step 311, if users choose “yes”, then through the circuitry the resident subroutine will provide the computer peripheral device 12 with power and start it. Otherwise, the resident subroutine will end the flow.

FIG. 4B is a flow chart that the computer peripheral device swaps from the host when the computer is in a running state. The flow comprises the following steps: Firstly, in step 312, users click the icon of swapping device, and tell the computer system 10 the information of the computer peripheral device 12 which is to be swapped. Secondly, in step 313, the software controller 24 gets the information of the position of the computer peripheral device 12. Then, in step 314, the resident subroutine of the software controller 24 displays the message of “enter your password”. Next, in step 315, the resident subroutine checks whether the password is correct. According to step 315, in step 316, if the password is correct, through the circuitry the resident subroutine will disconnect the computer peripheral device 12 from the computer system 10 and shut off it. Otherwise, the resident subroutine will end the flow. Further, in step 317, the resident subroutine displays the message of “whether to swap the computer peripheral device”. Furthermore, in step 318, if users choose “yes”, then the computer peripheral device 12 can be swapped from the slot. Otherwise, the resident subroutine will end the flow.

To sum up, the computer system of the present invention does not need a complicated software or hardware scheme, users can collocate the position of the computer peripheral device flexibly and do the operation of hot swap. Additionally, the present invention can also combine with software design to control the safety of hot swap, and enhance the reliability and merit of the computer system.

While the invention has been described with reference to various illustrative embodiments, the description is not intended to be construed in a limiting sense. Various modifications of the illustrative embodiments, as well as other embodiments of the invention, will be apparent to those skilled in the art upon reference to this description. It is therefore contemplated that the appended claims will cover any such modifications or embodiments as may fall within the scope of the invention defined by the following claims and their equivalents.

What is claimed is:

1. A computer system with hot swap function, comprising:
a computer peripheral device having a signal connector in a predetermined position;
a mother board having a basic input output system (BIOS);
a software controller for controlling the signal communication of said computer system and the power of said computer peripheral device;
a circuit board forming on one slot for accommodating said computer peripheral device, comprising a first connector, a second connector and a signal connection device;
wherein said computer peripheral device connects with one of said first connector and said second connector selectively by means of the predetermined position of said signal connector, then said signal connection device judges the type of said computer peripheral device from the connection signal and transmits the result of the judgment to said mother board, and then said software controller starts said computer peripheral device according to the result of the judgment.

2. The computer system as claimed in claim 1, comprising the following steps when inserting said computer peripheral device into the slot:
(a) said signal connector connects with said circuit board;
(b) the circuitry of said circuit board transmits the connection signal to said signal connection device;
(c) said signal connection device automatically detects the type of said computer peripheral device from the connection signal;
(d) said BIOS gets the detection result from said signal connection device;
(e) said software controller calls said BIOS and getting the detection result; and
(f) said software controller provides said computer peripheral device with the power and starts said computer peripheral device according to the detection result.

3. The computer system as claimed in claim 1, comprising the following steps when swapping said computer peripheral device from the slot:
(a) said software controller gets the information of the position of said computer peripheral device;
(b) said software controller shuts off said computer peripheral device and the power thereof; and
(c) said software controller permits said signal connector releasing from said circuit board.

4. The computer system as claimed in claim 1, further comprising an operation system (OS), through said software controller said operation system checks users' competence to decide on starting up and shutting off said computer peripheral device.

5. The computer system as claimed in claim 1, wherein said circuit board further comprises a third connector forming on another slot for accommodating said computer peripheral device, said third connector is for connecting with said computer peripheral device.

6. The computer system as claimed in claim 1, wherein said computer peripheral device can be one selected from floppy disk drive (FDD), hard disk drive (HDD), CD-ROM, CD-R/W, DVD and other data storage devices.

7. The computer system as claimed in claim 1, wherein said first connector is for connecting with the computer peripheral device having FDD interface.

8. The computer system as claimed in claim 1, wherein said second connector and said third connector are for connecting with the computer peripheral device having IDE2 interface.

9. A circuit board for running the function of hot swap, which is formed on a slot for accommodating a computer peripheral device having a signal connector, said circuit board comprising:
a first connector for connecting with said signal connector of said computer peripheral device;
a second connector for connecting with said signal connector of said computer peripheral device; and
a signal connection device for connecting with a mother board of a computer system, said mother board having a basic input output system (BIOS) and a circuitry for connecting said first connector and said second connector with said signal connection device;
wherein said computer system further comprising a software controller for controlling the signal communication of said computer system and the power of said computer peripheral device, said computer peripheral device connects with one of said first connector and said second connector selectively by means of the predetermined position of said signal connector, then said signal connection device judges the type of said computer peripheral device from the connection signal and transmits the result of the judgment to said mother board, and then said software controller starts said computer peripheral device according to the result of the judgment.

10. The circuit board as claimed in claim 9, further comprising a third connector forming on another slot for accommodating said computer peripheral device, said third connector is for connecting with said computer peripheral device.

11. The circuit board as claimed in claim 9, wherein said computer system further comprises an operation system (OS), through said software controller said operation system checks users' competence to decide on starting up and shutting off said computer peripheral device.

12. The circuit board as claimed in claim 9, wherein said computer peripheral device can be one selected from floppy disk drive (FDD), hard disk drive (HDD), CD-ROM, CD-R/W, DVD and other data storage devices.

13. The circuit board as claimed in claim 9, wherein said first connector is for connecting with the computer peripheral device having FDD interface.

14. The circuit board as claimed in claim 9, wherein said second connector and said third connector are for connecting with the computer peripheral device having IDE2 interface.
